(19) United States
(12) Patent Application Publication
(10) Pub. No.: US 2019/0266665 A1
(43) Pub. Date: Aug. 29, 2019

(54) MANAGING SUBSCRIPTION LIFE-CYCLES

(71) Applicant: HEWLETT PACKARD ENTERPRISE DEVELOPMENT LP, Houston, TX (US)

(72) Inventors: Bo Wang, Shanghai (CN); Jian-Hua Yang, Shanghai (CN)

(21) Appl. No.: 15/907,757

(22) Filed: Feb. 28, 2018

(51) Int. Cl. G06Q 30/06

(52) U.S. Cl. CPC G06Q 30/0645

(57) ABSTRACT

In some examples, a subscription life-cycle management system is disclosed. The system may include a memory to store a set of definitions that define a first state of a finite state machine representing transition logic of a subscription life-cycle, a second state of the finite state machine, and an event capable of causing a transition between the first state and the second state; and a set of rules that define possible transitions between the first state and the second state. The system may include an execution engine to execute the transition between the first state and the second state in response to a determination that the event has taken place. The system may include a modification engine to receive an instruction to modify the set of definitions or the set of rules; and modify the transition logic based on the received instruction. A method and a machine-readable medium are also disclosed.

### BACKGROUND

Some business models involve the use of a subscription-based model, whereby customers subscribe to various products or services provided by a company. For example, a telecom provider may provide a range of subscription options to its customers, each subscription option having a different associated cost, and providing a different level of service.

Within a subscription-based business model, various entities may each have their own life-cycle. A life-cycle of an entity describes occurrences or changes that take place in respect of the entity in response to particular actions or events. One entity, such as a subscriber, may have a life-cycle which involves a particular service being provided if a subscription fee is paid, and wherein that service is not provided if the subscription fee is not paid. Business logic used to describe a life-cycle for an entity may be very detailed and complex and may depend on other entities and on actions performed in respect of those other entities.

Subscription life-cycle management (also referred to as customer or subscriber life-cycle management) refers to the management of subscription life-cycles, such as the life-cycle or life-cycles of each entity. The subscription life-cycle management involves modifying the complex business logic which describes the life-cycle.

### BRIEF DESCRIPTION OF DRAWINGS

Examples will now be described, by way of non-limiting example, with reference to the accompanying drawings, in which:

FIG. 1 is a simplified schematic of an example of a subscription life-cycle management system;

FIG. 2 is an example of business logic represented as a flow diagram (FIG. 2A) and as a finite state chart (FIG. 2B);

FIG. 3 is an example of a state transition table of a finite state machine;

FIG. 4 is a flowchart of an example of a subscription life-cycle management method;

FIG. 5 is a flowchart of a further example of a subscription life-cycle management method; and

FIG. 6 is a simplified schematic of an example of a machine-readable medium and a processor.

### DETAILED DESCRIPTION

A subscription-based business model may include a plurality of entities. In one example, a telecommunications service provision business (hereinafter “telecoms company”) may provide telecommunications services to its customers. For example, the telecoms company may provide a service by which a customer is able to make telephone calls from his or her mobile device. The telecoms company may, in some examples, provide the mobile device to the customer as part of its service. The various services may be provided to a customer if the customer has paid a subscription fee and, similarly, services may be taken away from the customer or restricted (e.g. the service provision may be terminated) if the customer fails to pay the subscription fee. In such an example, the “entities” of the business model may include subscribers, devices (e.g. the mobile devices provided to the subscribers), and the type of subscription package to which the subscriber is subscribed. In other examples, entities of a business model may include an account of the subscriber, a monetary balance (e.g. a balance in a subscriber's account), a quota (e.g. an allowance of available data, or an allowance of telephone call minutes) or a counter (e.g. to determine an accumulated usage of data, call minutes, money, and the like, in a given duration). Each entity may have its own specific life-cycle according to the particular business model with which they are associated.

Life-cycles of various entities may be exemplified using the following scenarios. In a first example, in which the entity is a subscriber to a service, different levels of subscription may entitle the subscriber to different grades of service. For example, a top-level (e.g. VIP) subscriber may be provided with a grace period in which to top-up his or her account (e.g. a monetary balance) if the balance of the account is used up. A regular, lower-level subscriber may, on the other hand, be blocked if the balance on their account is used up. In a second example, in which the entity is a product or package provided by the company to its customers, different products and packages may have different life-cycles. For example, it may be possible to purchase a particular product without the product being activated immediately (e.g. the product may not immediately be available for use by the customer). A product may be activated upon its first use by the subscriber, and the product may automatically be renewed according to a defined renewal arrangement (e.g. a payment may be taken on a monthly basis to enable the product to remain available to the customer). Other products, however, may be activated upon purchase. In a third example, in which the entity is a monetary balance of a customer's account, an account may behave differently depending on the nature of the monetary balance. For example, a monetary balance may have a specific expiration time (i.e. the balance is set to zero if it is not used by a particular date or within a defined period). In some cases, increasing the monetary balance may extend the expiration time by a defined extended duration which depends on the amount by which the monetary balance was increased. In some examples, a life-cycle may involve multiple entities. For example, increasing a monetary balance in a subscriber's account may keep a subscription live and, if the increase in the monetary balance is above a threshold level, may result in an additional gift or bonus relevant to a different entity (e.g. quota), such as a bonus data allowance for a month.

Complex business logic may be used to define the behaviour of each entity. In some examples, the behaviour of one entity may depend on the behaviour of another entity, thereby increasing the complexity of the business logic. For example, a subscription may be activated immediately (e.g. upon purchase), it may be activated upon first usage, or it may be activated at some defined time in the future. The business logic for the subscription entity is therefore intended to cover all possibilities within the business. In addition, if a monetary balance associated with the subscription were to expire, then the subscription may change, resulting in a further possibility to be included in the business logic.

According to examples disclosed herein, management of subscription life-cycles is enabled by representing the business logic using a finite state machine. A finite state machine (FSM) is a model which can be used to represent a finite number of states and how a change or transition may be made between those states in response to an external input, referred to as an event. By representing complex business logic using a finite state machine, the business logic may be simplified and may be made easier to understand.

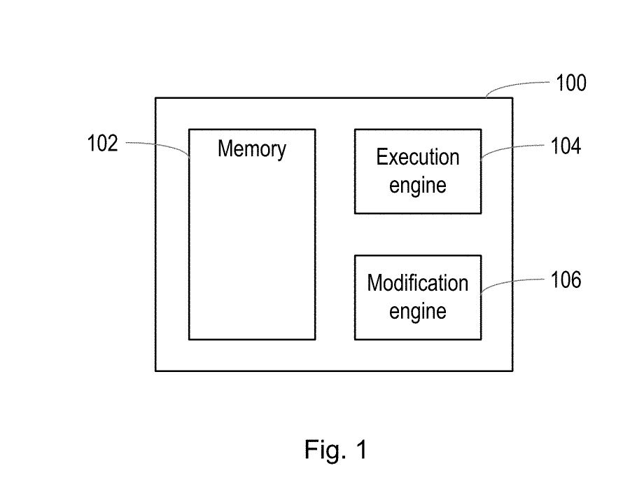

FIG. 1 is a simplified schematic of a system 100 for managing subscription life-cycles. The system 100 may be referred to as a subscription life-cycle management system or a subscriber life-cycle management system. The system 100 comprises a memory 102, an execution engine 104 and a modification engine 106. The execution engine 104 and the modification engine 106 may, in some examples, form part of a single engine, and either or both may comprise a processor (or multiple processors) to perform functions of the execution engine and/or the modification engine.

The memory 102 may store, or may be capable of storing, a set of definitions that define a first state of a finite state machine representing transition logic of a subscription life-cycle, a second state of the finite state machine, and an event capable of causing a transition between the first state and the second state. The memory 102 may also store, or may be capable of storing, a set of rules that define possible transitions between the first state and the second state. In some examples, the finite state machine may include additional states, such as a third state, a fourth state, a fifth state, and so on, and rules that define possible transitions between any of the states.

The execution engine 104 is to execute the transition between the first state and the second state in response to a determination that the event has taken place. Implementations of the execution engine 104 include electronic circuitry (i.e., hardware) such as an integrated circuit, programmable circuit, application integrated circuit (ASIC), controller, processor, semiconductor, processing resource, chipset, or other type of hardware component capable of executing the transition between the first state and the second state in response to a determination that the event has taken place. Alternatively, the execution engine 104 may include instructions (e.g., stored on a machine-readable medium) that, when executed by a hardware component (e.g., controller and/or processor) causes the transition between the first state and the second state to be executed in response to a determination that the event has taken place, accordingly. The modification engine 106 is to receive an instruction to modify the set of definitions or the set of rules. The modification engine 106 is further to modify the transition logic based on the received instruction. Implementations of the modification engine 106 include electronic circuitry (i.e., hardware) such an integrated circuit, programmable circuit, application integrated circuit (ASIC), controller, processor, semiconductor, processing resource, chipset, or other type of hardware component capable of receiving an instruction to modify the set of definitions or the set of rules, and modifying the transition logic based on the received instruction. Alternatively, the modification engine 106 may include instructions (e.g., stored on a machine-readable medium) that, when executed by a hardware component (e.g., controller and/or processor) causes an instruction to modify the set of definitions or the set of rules to be received, and modifies the transition logic based on the received instruction, accordingly.

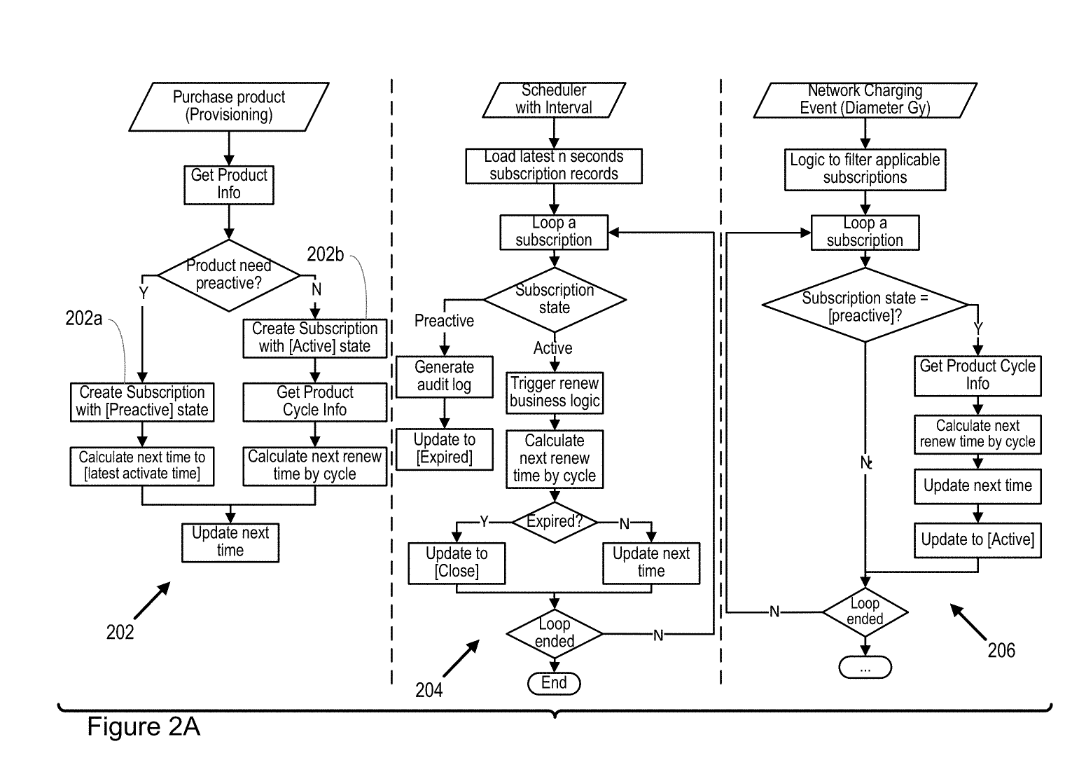

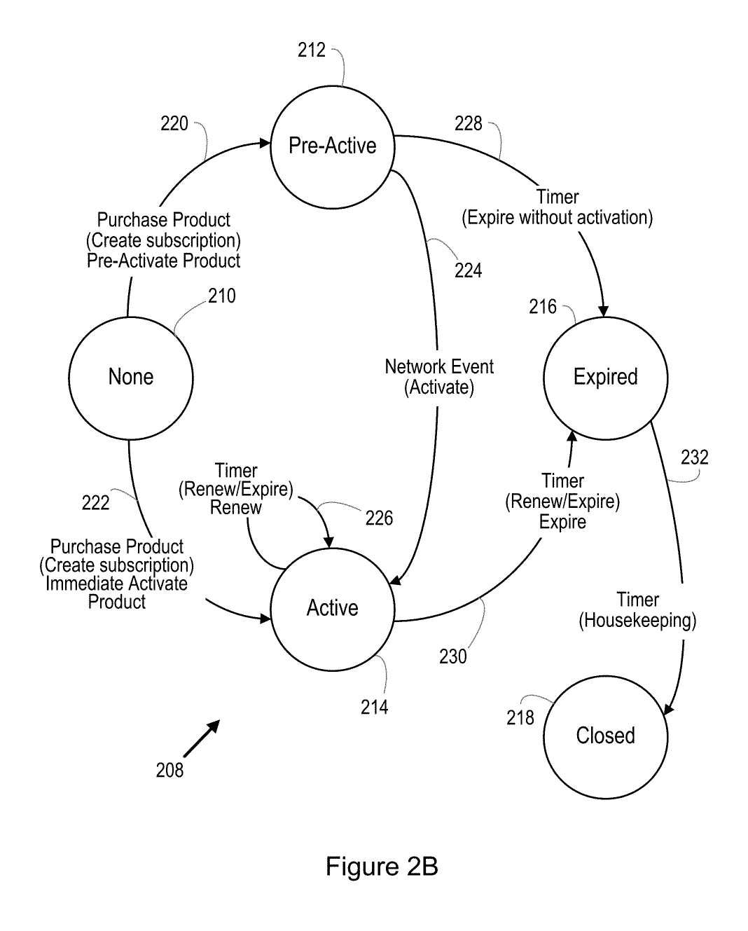

The states of the finite state machine may correspond to states relevant to a particular entity. Thus, in some examples, each entity may have an associated finite state machine or multiple associated finite state machines. Examples of such states will be described with reference to FIG. 2, which shows an example of business logic for a subscription-based telecoms company (in FIG. 2A), and an example of part of the business logic represented as a finite state machine (in FIG. 2B).

In FIG. 2A, first business logic portion 202, second business logic portion 204 and third business logic portion 206 represent three parts of a subscription life-cycle logic representation. In this example, the first business logic portion 202 relates to provisioning a purchased product, and includes, at blocks 202a and 202b, creating two different types of subscription. At block 202a, a subscription is created having a “pre-active” state, and at block 202b, a subscription is created having an “active” state. Thus, “pre-active” and “active” are to possible states associated with the “subscription” entity.

FIG. 2B includes a representation 208 of a finite state machine representing part of the business logic 202, 204, 206. Specifically, the representation 208 is a state chart for the “subscription” entity of the business logic. The state chart 208 includes all possible states 210 to 218 associated with the entity (i.e. subscription), and all possible transitions 220 to 232 between the states. In this example, the possible states associated with the subscription entity include “none” 210, “pre-active” 212, “active” 214, “expired” 216 and “closed” 218. Various inputs, or events, may result in transitions between the various states. According to the example of FIG. 2B, purchasing a product may lead to a subscription being created, the subscription requiring activation before it can be used. Such an event may result in a transition 220 from the “none” state 210 to the “pre-active” state 212. In other examples, purchasing a product may lead to the creation of a subscription which is activated immediately. Such an event may result in a transition 222 from the “none” state 210 to the “active” state 214. A subscription in the “pre-active” state 212 may be activated by some event, such as a network event, resulting in a transition 224 from the “pre-active” state 212 to the “active” state 214. While a subscription is in the “active” state 214, the subscription may be renewed or expire, for example after a defined period of time has elapsed. If a subscription is renewed, then the subscription a transition from the “active” state 214 back to itself via a transition 226. If a subscription is the “pre-active” state 212 is not activated within a defined period of time, then the subscription may undergo a transition 228 from the “pre-active” state 212 to the “expired” state 216. Similarly, a subscription in the “active” state 214 may undergo a transition 230 to the “expired” state 216 if subscription is not renewed within a defined period of time. If a subscription in the “expired” state 216 remains in that state for a defined period of time, then it may undergo a transition 232 to a “closed” state 218.

Thus, a state transition, such as the transitions 220 to 232 in FIG. 2B may represent the logic which is executed when an event is triggered in respect of a particular state. The set of rules that define the possible transitions between states (e.g. between the first state and the second state) may, in some examples, comprise a rule chain, defining multiple transitions (e.g. between multiple states) which may take place upon detection of a particular event.

When it is determined that an event (i.e. an event defined in the set of definitions) has taken place which is capable of causing a transition between the first state and the second state, the execution engine 104 executes the transition from the first state to the second state, in accordance with the set of rules. In some examples, the execution engine 104 may execute multiple transitions in response to a determination that the event has taken place. For example, an entity may transition between the first state and a third state, via the second state. In another example, performing the event may cause one entity to transition between the first state and the second state, and another entity to transition between a third state and a fourth state.

The determination that an event has taken place may be made, for example, by a processing apparatus in the system 100, or associated with the system. The processing apparatus performing the determination may comprise the execution engine 104.

It may be intended that the business logic be modified, for example to include a new state or to incorporate an additional transition between various states. Making changes to the business logic 202, 204, 206 may be particularly challenging due to the complex nature of the business logic when presented in that manner. For example, the telecoms company may wish to add into the business logic an additional “blocked” state, which applies to a customer who has failed to pay a subscription fee. Modifying the business logic 202, 204, 206 is not a straightforward task as the introduction of a new state may involve consequential changes being made in respect of multiple entities. Moreover, adding a new state by modifying the business logic 202, 204, 206 may involve consequential changes being made to other existing transitions within the business logic. Thus, the modification engine 106 is capable of modifying the transition logic of the finite state machine based on a received instruction to modify a definition in the set definitions and/or a rule in the set of rules.

In some examples, an instruction to modify a definition or a rule may be received by an operator, such as an operator of the subscription life-cycle management system 100. For example, the operator may input the modification instruction using a user interface presented to them via a computing device. In other examples, the instruction to modify a definition or a rule may be received in an automated manner. For example, an instruction may be generated by an associated processing device in response to an event or trigger, and the instruction may be delivered to the modification engine automatically.

The business logic may, in some examples, be represented in the form of a state transition table. A state transition table may show the state into which a finite state machine will move or transition, based on the current state of the finite state machine and other inputs or events. In some examples, the execution engine 104 generate, or be capable of generating, based on the stored definitions and rules, a state transition table that defines relationships between the states, the state transitions and the event.

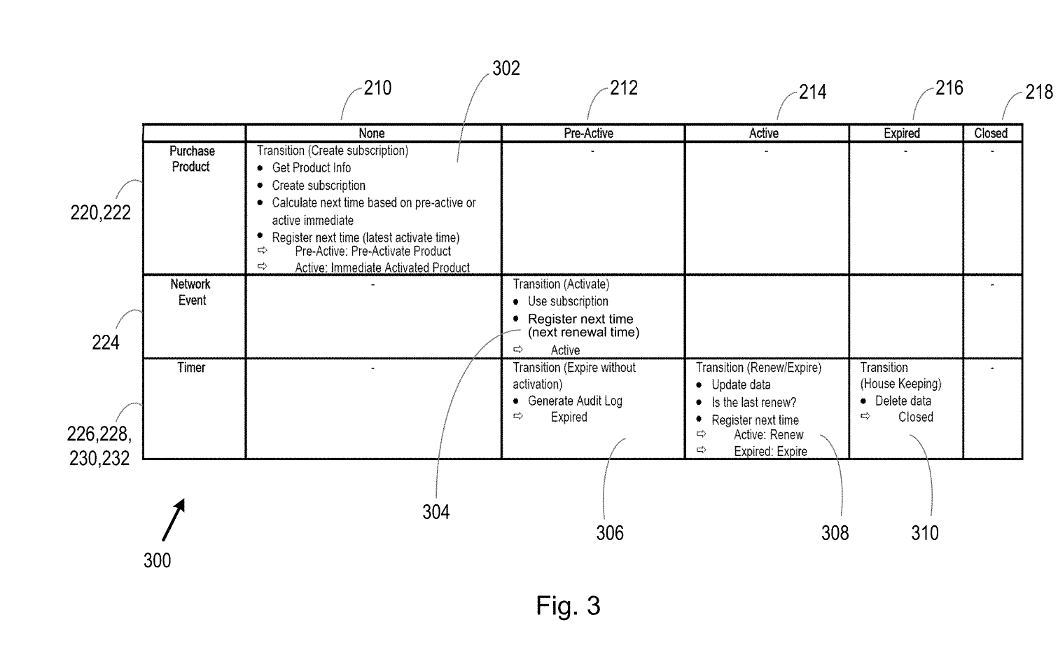

FIG. 3 is an example of a state transition table 300 corresponding to the state chart shown in FIG. 2B. In the state transition table 300, the states 210 to 218 are presented at the tops of columns along the top of the table, and the possible transitions 220 to 232 between the states are presented down the left-hand side of the table. In this example, the transitions 220 and 222 are grouped together in a first row, labelled “Purchased product”, the transition 224 is presented in the second row, labelled “Network event”, and the transitions 226, 228, 230 and 232 are grouped together in a third row, labelled “Timer”. The possible transitions relevant to each row in the table are presented in row/column intersection cells 302 to 310. For example, the transition 220, whereby purchasing a particular product may result in a transition from the “none” state 210 to the “pre-active” state 212, is presented as an alternative in the cell 302 along with the transition 222, whereby purchasing a particular product may result in a transition from the “none” state 210 to the “active” state 214.

The row/column intersection cells 302 to 310 may also include additional information regarding the business logic, which may not be presented in the state chart, such as the state chart of FIG. 2B. For example, the row/column intersection cells may include information regarding a rule or a rule chain relevant to the corresponding state, such that a viewer of the state transition table 300 may be provided with a better understanding of the business logic presented therein. In the example state transition table 300 shown in FIG. 3, the row/column intersection cell 302 includes details of the general type of transition (i.e. create subscription in response to a product being purchased), and the two possible transitions which might take place (i.e. pre-active or active), depending on the type of product purchased. The intersection 302 also includes four rules, namely “Get product info”, “Create subscription”, “Calculate next time based on pre-active or active immediate” and “Register next time (latest activate time)”. These rules may be considered additional information which may aid a viewer of the state transition table 300 in better understanding the business logic.

Thus, in some examples, the state transition table may be presented to an operator, for example via a user interface and/or a display, so that the operator is able to see the additional information relating to the business logic.

In some examples, the execution engine 104 may comprise a timing engine to effect the transition between the first state and the second state after expiry of a defined duration or at a defined time. The timing engine may, for example, comprise a timing mechanism. The timing engine may, in some examples, determine when a defined duration of time has elapsed after a particular event. In some examples, a state transition may take place after a defined duration has passed or expired. For example, a timer may begin upon detection of a particular event, such as the first use of a product by a subscriber. The execution engine 104 may perform a particular action, such as terminating a service, upon expiry of the defined duration. In an example, the execution engine 104 may use the timing engine, or timer, to determine when a state transition is to take place. For example, a subscriber may subscribe to a particular service on a month-by-month basis, and the timing engine may cause a transitions from an “active” state (214 in FIG. 2B) to an “expired” state (216 in FIG. 2B) after a month has passed from the initiation of the service. In other examples, the timing engine may measure absolute time, such that the execution engine 104 may perform a particular action at a particular defined time. A state transition may take place on a particular date or at a particular time, for example. In some examples, a subscription service may expire (i.e. a transition may occur from an “active” state (214 in FIG. 2B) to an “expired” state (216 in FIG. 2B) at midnight on the last day of a particular month.

The transitions 226, 228, 230 and 232 may, in some examples, be effected using the timing engine of the execution engine 104. In some examples, the set of rules stored in the memory 102 may include rules based on timings measured or determined using the timing engine.

As noted above, subscription-based business model may include a plurality of entities, and business logic for each entity may be represented using a finite state machine, or multiple finite state machines. In some examples, the memory 102 may store, or be capable of storing, a set of entity definitions that define entities having subscription life-cycles. The memory 102 may store, or be capable of storing, a set of entity rules that define the subscription life-cycle of each entity. If it is intended that a portion of the business logic be modified or adapted, then a state transition chart and/or a state transition table for each finite state machine may be generated and/or presented to an operator so that the operator can observe the business logic for each entity. By storing the entity definitions and entity rules in the memory 102, any consequential changes in a second entity resulting from a change made to a first entity may also be effected. In some examples, the execution engine 104 may be to execute the transition between the first state and the second state for an entity based on the entity rules for that entity. Thus, the transitions may differ for each entity.

Representing the business logic as a finite state machine, or as a plurality of finite state machines, and presenting each finite state machine in the form of a state transition chart and/or a state transition table may enable changes to be made to the business logic in a user-friendly way. According to an example, an operator who intends to add a new “blocked” state into the business logic may take the following actions. First, the operator may view the state transition table for the relevant finite state machine intended to be updated. Then, the operator may add the new state (i.e. “blocked”), along with an event or a plurality of events that would cause a transition from other states to the “blocked” state and/or from the “blocked” state to other states. The operator may then add rules, such as transition rules or rule chains defining the possible transitions. For example, the transitions may be added into the row/column intersection cells (302 to 310 in FIG. 3).

Once the intended changes or additions have been made in the state transition table, the modification engine 106 may generate, or be capable of generating, based on the modified transition logic, a state transition chart representing the modified transition logic. In other words, once the operator has updated the state transition table, a corresponding state transition chart may be generated. The operator may view the modified state chart corresponding to the modified state transition table to view the updated business/transition logic and to verify that any changes made to the states, events and/or transitions are as intended.

As discussed above, the state chart may be presented in the form as shown in FIG. 2B, with the various states and the possible transitions between states. In some examples, the modified state chart may be generated or built one part at a time (e.g. first the states, then the events, then the transitions, and so on) so that an operator can see clearly the effect of adding the new state or modifying the logic. In some examples, the state chart may be generated by populating the chart with all of the states, then iteratively adding each event, then, for each event, iterating the corresponding transition, then adding lines connecting the states, based on the transitions. In some examples, additional information may be added, based on the additional information included in the state transition table (e.g. in the row/column intersection cells 302 to 310). In this way, all of the relevant information from the state transition table may be displayed to an operator in the state chart.

In some examples, the additional information from the state transition table may be displayed in the state chart in response to a particular action taken by an operator. For example, moving or hovering a cursor over a particular transition presented in the state chart, or selecting a particular transition (e.g. by clicking a mouse button) may cause the additional information to be displayed (e.g. temporarily), so that the operator can view the additional information at a particular time. In this way, the state chart may not permanently be populated with all of the available information and, therefore, an operator may not be presented with too much information, which could otherwise cause confusion or make the state chart difficult to interpret.

In examples where the business logic is represented using a plurality of finite state machines, the modification engine 106 may modify the transition logic corresponding to a first finite state machine, and may also modify transition logic corresponding to other finite state machines of the plurality of finite state machines. In some examples, the modification engine 106 may comprise a sub-modification engine to effect a modification to transition logic corresponding to a second finite state machine based on the modification made to the transition logic corresponding to a first finite state machine. Thus, if a modification (e.g. an addition of a state) made to the transition logic corresponding to a first finite state machine as a consequential effect on transition logic corresponding to a second finite state machine (e.g. a finite state machine of a different entity), then the sub-modification engine may make the corresponding modification to the second finite state machine logic, or the logic of any other finite state machines which may be affected.

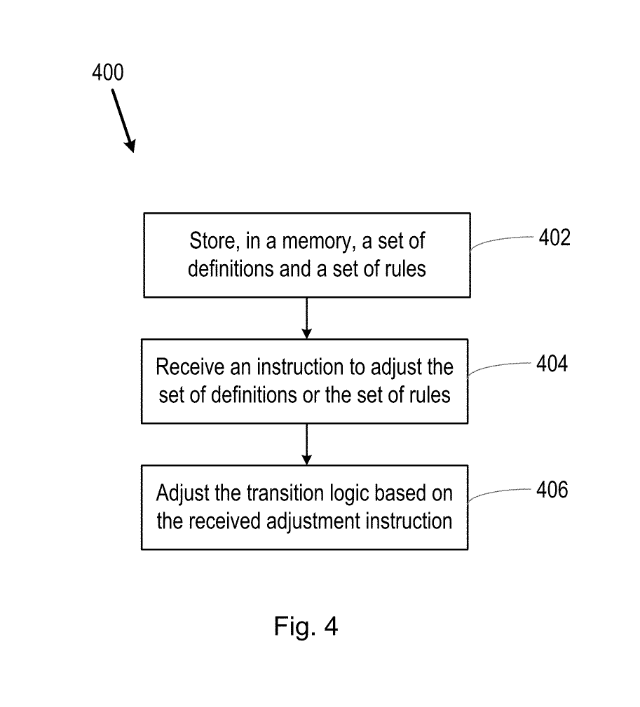

According to examples disclosed herein, a subscription life-cycle management is disclosed. FIG. 4 is a flowchart of an example of a method 400. The method 400 may, for example, comprise a subscription life-cycle management method. The method 400 comprises, at block 402, storing, in a memory, a set of definitions and a set of rules. The set of definitions define a first state of a finite state machine representing transition logic of a subscription life-cycle, a second state of the finite state machine, and an event capable of causing a state transition between the first state and the second state. The set of rules define possible state transitions between the first state and the second state. At block 404, the method 400 comprises receiving an instruction to adjust the set of definitions or the set of rules. As explained in the above examples, the adjustment instruction may be received manually (e.g. as an input by an operator) or automatically (e.g. as an input triggered by some action or event). The method 400 comprises, at block 406, adjusting the transition logic based on the received adjustment instruction.

Thus, in response to receiving an instruction to adjust or modify a definition or a rule defining states, events or transitions of a finite state machine, the method may make a corresponding adjustment to the transition logic represented by the finite state machine. In this way, an adjustment to the transition logic may be made by an operator even though the operator may not fully understand or comprehend the complex business logic.

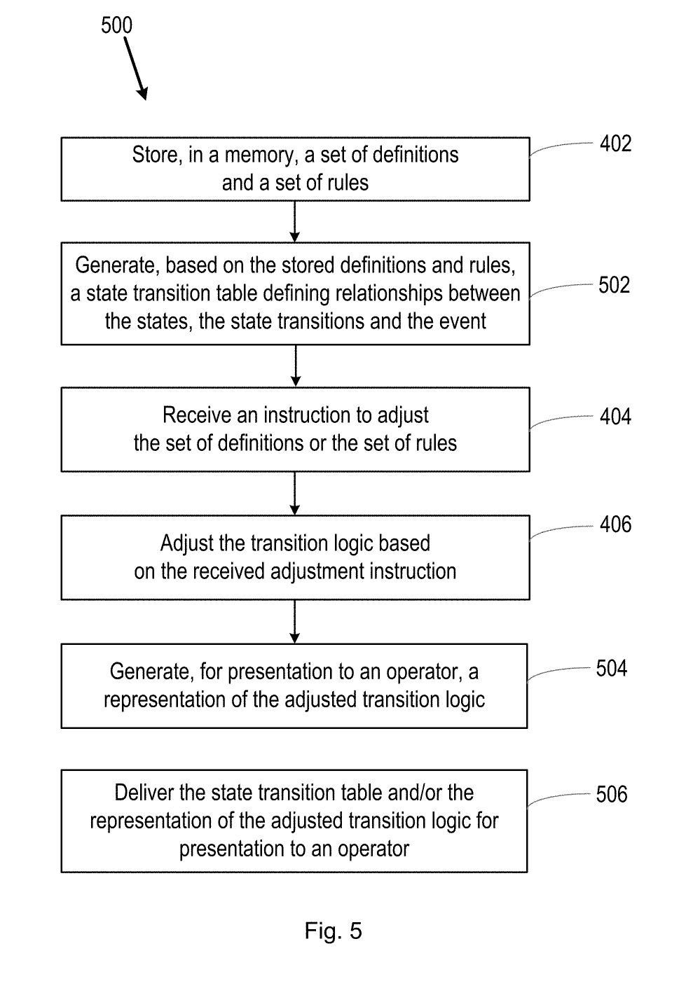

FIG. 5 is a flowchart of a further example of a subscription life-cycle management method 500. The method 500 may include blocks of the method 400. The method 500 may comprise, at block 502, generating, based on the stored definitions and rules, a state transition table that defines relationships between the states, the state transitions and the event. In some examples, the state transition table may be generated after the set of definitions and the set of rules have been stored in the memory (block 402), and before an adjustment instruction has been received (block 404). The state transition table, such as the state transition table 300 shown in FIG. 3, generated at block 502 may be presented to an operator, for example via a user interface. Such a state transition table may include details of the first and second states of the finite state machine, details of the event or events capable of causing a state transition, and details of the possible state transitions that may occur. In some examples, the state transition table may further include additional information, such as the information shown in the row/column intersection cells 302 to 310 of FIG. 3.

At block 504, the method 500 may comprise generating, for presentation to an operator, a representation of the adjusted transition logic. The representation of the adjusted transition logic may be generated after the transition logic has been adjusted based on the received adjustment instruction (block 406). In some examples, the representation of the adjusted transition logic may comprise a state transition chart, or state chart. Generating the representation (block 504) may, in some examples, comprise constructing a representation including the states, the state transitions, the events and the relationships between the states, the state transitions and the events.

The method 500 may comprise, at block 506, delivering the state transition table and/or the representation of the adjusted transition logic for presentation to an operator. By presenting the state transition table and/or the state transition chart to an operator, the operator may be able to understand the business logic represented by the finite state machine, and may not be overwhelmed with complex details in the business logic.

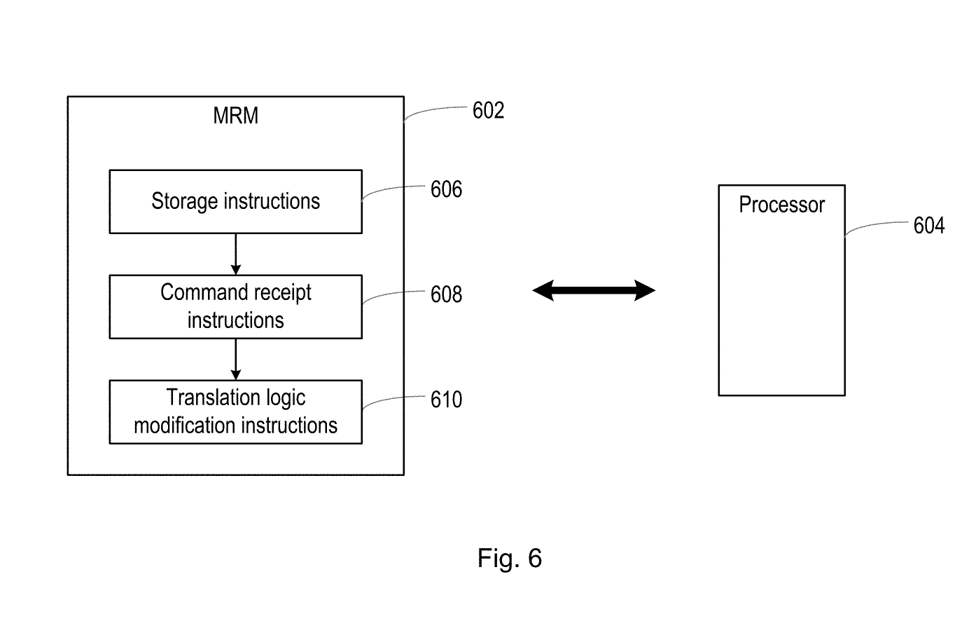

According to examples described herein, a machine-readable medium is disclosed. FIG. 6 is a simplified schematic of an example of a machine-readable medium 602 and a processor 604. The machine-readable medium 602 comprises instructions which, when executed by a processor, such as the processor 604, cause the processor to perform the methods disclosed herein. In some examples, the machine-readable medium 602 may comprise instructions which, when executed by the processor 604, cause the processor to store, in a memory, a set of definitions that define a first state of a finite state machine representing transition logic of a subscription life-cycle, a second state of the finite state machine, and an event capable of causing a state transition between the first state and the second state; and a set of rules that define possible state transitions between the first state and the second state. In some examples, the storing may be performed by executing storage instructions 606. The machine-readable medium 602 may comprise instructions which, when executed by the processor 604, cause the processor to receive a command to edit, add to or delete from the set of definitions or the set of rules. In some examples, receiving a command may be performed by executing command receipt instructions 608. The machine-readable medium 602 may comprise instructions which, when executed by the processor 604, cause the processor to modify the transition logic based on the received command. In some examples, modifying the transition logic may be performed by executing transition logic modification instructions 610.

In some examples, the machine-readable medium 602 may comprise instructions (e.g. state transition table generation instructions) which, when executed by the processor 604, cause the processor to generate, based on the stored definitions and rules, a state transition table that defines relationships between the states, the state transitions and the event. In some examples, instructions (e.g. state transition chart generation instructions), when executed by the processor 604, may cause the processor to generate, based on the modified transition logic, a state transition chart representing the modified transition logic.

In some examples, the machine-readable medium 602 may comprise instructions (e.g. state transition table delivery instructions) which, when executed by the processor 604, cause the processor to deliver the state transition table for presentation to an operator.

The machine-readable medium 602 may, in some examples, comprise instructions (e.g. state transition chart construction instructions) which, when executed by the processor 604, cause the processor to construct the state transition chart by including in the chart the states, the state transitions, the events and the relationships between the states, the state transitions and the events.

In some examples, the machine-readable medium 602 may comprise instructions (e.g. state transition chart delivery instructions) which, when executed by the processor 604, cause the processor to deliver the state transition chart for presentation to an operator.

The machine-readable medium 602 may, in some examples, comprise instructions (e.g. modification instructions) which, when executed by the processor 604, cause the processor to effect a modification to transition logic corresponding to a second finite state machine based on the modification made to the transition logic corresponding to a first finite state machine.

Examples in the present disclosure can be provided as methods, systems or machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A subscription life-cycle management system comprising:
a memory to store:
a set of definitions that define a first state of a finite state machine representing transition logic of a subscription life-cycle, a second state of the finite state machine, and an event capable of causing a transition between the first state and the second state; and
a set of rules that define possible transitions between the first state and the second state;
an execution engine to execute the transition between the first state and the second state in response to a determination that the event has taken place; and
a modification engine to:
receive an instruction to modify the set of definitions or the set of rules; and
modify the transition logic based on the received instruction.

2. A system according to claim 1, wherein the modification engine is to:
generate, based on the stored definitions and rules, a state transition table that defines relationships between the states, the state transitions and the event.

3. A system according to claim 1, wherein the execution engine comprises a timing engine to effect the transition between the first state and the second state after expiry of a defined duration or at a defined time.

4. A system according to claim 1, wherein the memory is further to store:
a set of entity definitions that define entities having subscription life-cycles; and
a set of entity rules that define the subscription life-cycle of each entity.

5. A system according to claim 4, wherein the execution engine is to execute the transition between the first state and the second state for an entity based on the entity rules for that entity.

6. A system according to claim 1, wherein the modification engine is to:
generate, based on the modified transition logic, a state transition chart representing the modified transition logic.

7. A system according to claim 1, wherein the modification engine comprises a sub-modification engine to effect a modification to transition logic corresponding to a second finite state machine based on the modification made to the transition logic corresponding to a first finite state machine.

8. A subscription life-cycle management method comprising:
storing, in a memory:
a set of definitions that define a first state of a finite state machine representing transition logic of a subscription life-cycle, a second state of the finite state machine, and an event capable of causing a state transition between the first state and the second state; and
a set of rules that define possible state transitions between the first state and the second state;
receiving an instruction to adjust the set of definitions or the set of rules; and
adjusting the transition logic based on the received adjustment instruction.

9. A method according to claim 8, further comprising:
generating, based on the stored definitions and rules, a state transition table that defines relationships between the states, the state transitions and the event.

10. A method according to claim 8, further comprising:
generating, for presentation to an operator, a representation of the adjusted transition logic.

11. A method according to claim 10, wherein the representation of the adjusted transition logic comprises a state transition chart.

12. A method according to claim 11, wherein generating the representation comprises constructing a representation including the states, the state transitions, the events and the relationships between the states, the state transitions and the events.

13. A method according to claim 9, further comprising:
delivering the state transition table and/or a representation of the adjusted transition logic for presentation to an operator.

14. A machine-readable medium comprising instructions which, when executed by a processor, cause the processor to:
store, in a memory:
a set of definitions that define a first state of a finite state machine representing transition logic of a subscription life-cycle, a second state of the finite state machine, and an event capable of causing a state transition between the first state and the second state; and
a set of rules that define possible state transitions between the first state and the second state;
receive a command to edit, add to or delete from the set of definitions or the set of rules; and
modify the transition logic based on the received command.

15. A machine-readable medium according to claim 14, wherein the instructions, when executed by a processor, cause the processor to:
generate, based on the stored definitions and rules, a state transition table that defines relationships between the states, the state transitions and the event.

16. A machine-readable medium according to claim 15, wherein the instructions, when executed by a processor, cause the processor to:
deliver the state transition table for presentation to an operator.

17. A machine-readable medium according to claim 14, wherein the instructions, when executed by a processor, cause the processor to:
generate, based on the modified transition logic, a state transition chart representing the modified transition logic.

18. A machine-readable medium according to claim 17, wherein the instructions, when executed by a processor, cause the processor to:
construct the state transition chart by including in the chart the states, the state transitions, the events and the relationships between the states, the state transitions and the events.

19. A machine-readable medium according to claim 17, wherein the instructions, when executed by a processor, cause the processor to:
deliver the state transition chart for presentation to an operator.

20. A machine-readable medium according to claim 14, wherein the instructions, when executed by a processor, cause the processor to:
effect a modification to transition logic corresponding to a second finite state machine based on the modification made to the transition logic corresponding to a first finite state machine.
